(19) United States
(12) Patent Application Publication
(10) Pub. No.: US 2013/0329017 A1
(43) Pub. Date: Dec. 12, 2013

(54) VEHICLE-MOUNTED CAMERA DEVICE

(71) Applicants: Jun Hayakawa, Hitachinaka (JP); Masaaki Fukuhara, Mito (JP); Tomoyuki Kataishi, Hitachinaka (JP)

(72) Inventors: Jun Hayakawa, Hitachinaka (JP); Masaaki Fukuhara, Mito (JP); Tomoyuki Kataishi, Hitachinaka (JP)

(73) Assignee: Hitachi Automotive Systems, Ltd., Ibaraki (JP)

(21) Appl. No.: 14/001,364

(22) PCT Filed: Mar. 1, 2012
(86) PCT No.: PCT/JP2012/055253

§ 371 Date: Aug. 23, 2013

(30) Foreign Application Priority Data
Mar. 4, 2011 (JP) 2011-047079

(51) Int. Cl. H04N 7/18

(52) U.S. Cl. CPC H04N 7/18
USPC 348/47

(57) ABSTRACT

Vehicle-mounted camera device includes first imaging unit, second imaging unit, image control unit for outputting imaging timing signals for controlling imaging timings of first imaging unit and second imaging unit to the first imaging unit and the second imaging unit, and outputting transmission timing control signals for controlling transmission timings of signals output from the first imaging unit and the second imaging unit to the first imaging unit and the second imaging unit, and an image processing unit for performing an image processing on the signals output from the first imaging unit and the second imaging unit. Image control unit temporarily offsets a timing of outputting the signal from the first imaging unit to the image processing unit from a timing of outputting the signal from the second imaging unit to the image processing unit based on the transmission timing control signals.

### TECHNICAL FIELD

The present invention relates to a vehicle-mounted camera device mounted on a vehicle.

### BACKGROUND ART

In recent years, techniques using a vehicle-mounted camera device as an external recognition sensor have been advanced as a vehicle-mounted safety device. Particularly, a stereo camera technique having two imaging units has been developed.

A stereo camera has imaging units on both the right and left sides, and an image control unit thereof controls imaging timings and image data transmission timings of the right and left imaging units.

Image data signals transmitted from the right and left imaging units are transmitted to an image processing unit at the center of the camera to be subjected to an image processing. Thereafter, a recognition application or the like uses the images processed in the image processing unit to recognize an object, thereby performing vehicle control depending on the recognition result.

The signals transmitted from the right and left imaging units may be clock signals or image synchronization signals in addition to the image data signals. The image synchronization signal indicates a vertical synchronization signal or a horizontal synchronization signal for determining an aspect size of the screen.

The stereo camera needs to calculate a disparity based on the images shot in the right and left imaging units for calculating a distance. The right and left imaging units need to shoot images at the same time for calculating the disparity.

In a typical stereo camera, the image control unit sends an imaging instruction to the right and left imaging units at the same time such that the right and left imaging units shoot images at the same time. The image data shot at the same time is transmitted to the image processing unit at the same timing.

Thus, when the image data signals, the clock signals or the image synchronization signals are transmitted from the right and left imaging units to the image processing unit, there is a problem that switching easily occurs in many signal lines at the same time and unnecessary large radiation noises are generated.

The vehicle-mounted camera device such as a stereo camera is attached near the room mirror in the vehicle interior in many cases. The circumstances around the room mirror are disadvantageous for an attachment position of a TV antenna (attached to or embedded in the front glass), a GPS antenna (on or near the dashboard) or EMC (Electromagnetic Compatibility). That is, even unnecessary small radiation noises can be easily caught by the TV antenna or GPS antenna. Under the condition of the attachment around the room mirror, a vehicle-mounted camera has a laterally elongate structure such as antenna-like structure, so as not to break a view of the driver or the passenger, which is disadvantageous for EMC.

Against the problem, as described in PTL 1, there is disclosed a structure capable of reducing unnecessary radiation noises by offsetting a data signal from a clock signal.

### CITATION LIST

### Patent Literature

PTL1: Japanese Patent Application Laid-Open No. 2001-345790

### SUMMARY OF INVENTION

### Technical Problem

However, with the structure in PTL 1, the stereo camera is less effective in reducing unnecessary radiation noises only by simply offsetting data from a clock, and consequently it employs a method for reducing a noise level by many noise canceling units (such as lug terminal, radio wave absorber and shield tape), which causes higher cost.

It is an object of the present invention to reduce unnecessary large radiation noises generated when image data signals, clock signals or image synchronization signals are transmitted from two imaging units to an image processing unit in a low-cost vehicle-mounted camera device.

### Solution to Problem

Preferred aspects of the present invention for solving the above problem are as follows.

A vehicle-mounted camera device according to the present invention includes a first imaging unit for shooting an image and outputting an image data signal, a second imaging unit for shooting an image and outputting an image data signal, an image control unit for outputting imaging timing signals for controlling imaging timings of the first imaging unit and the second imaging unit to the first imaging unit and the second imaging unit, and outputting transmission timing control signals for controlling transmission timings of signals output from the first imaging unit and the second imaging unit to the first imaging unit and the second imaging unit, and an image processing unit for performing an image processing on the signals output from the first imaging unit and the second imaging unit, wherein the image control unit temporally offsets a timing of outputting the signal from the first imaging unit to the image processing unit from a timing of outputting the signal from the second imaging unit to the image processing unit based on the transmission timing control signals.

A vehicle-mounted camera device includes a first imaging unit for shooting an image and outputting an image data signal, a second imaging unit for shooting an image and outputting an image data signal, an image control unit for outputting imaging timing signals for controlling imaging timings of the first imaging unit and the second imaging unit to the first imaging unit and the second imaging unit, and outputting transmission timing control signals for controlling transmission timings of signals output from the first imaging unit and the second imaging unit to the first imaging unit and the second imaging unit, an image processing unit for performing an image processing on the signals output from the first imaging unit and the second imaging unit, a first circuit device provided between the first imaging unit and the image processing unit, and a second circuit device provided between the second imaging unit and the image control unit, wherein a constant of the first circuit device is different from a constant of the second circuit device.

The present specification encompasses the contents described in the specification and/or the drawings in Japanese Patent Application No. 2011-047079 on which the priority of the present application is based.

### Advantageous Effects of Invention

It is possible to reduce unnecessary large radiation noises generated when image data signals, clock signals or image synchronization signals are transmitted from two imaging units to an image processing unit in a low-cost vehicle-mounted camera device.

### BRIEF DESCRIPTION OF DRAWINGS

FIG. 1 is a diagram illustrating a structure of a vehicle-mounted camera device according to the present invention.

FIG. 2 is a diagram illustrating transmission of image data in the vehicle-mounted camera device according to the present invention.

FIG. 3 is a waveform diagram in which serial signals transmitted from a first imaging unit and a second imaging unit to an image processing unit in the vehicle-mounted camera device according to the present invention are offset.

FIG. 4 is a waveform diagram in which the phases of the serial signals transmitted from the first imaging unit and the second imaging unit to the image processing unit in the vehicle-mounted camera device according to the present invention are offset by 180 degrees.

FIG. 5 is a waveform diagram in which parallel signals transmitted from the first imaging unit and the second imaging unit to the image processing unit in the vehicle-mounted camera device according to the present invention are offset.

FIG. 6 is a waveform diagram in which the phases of the parallel signals transmitted from the first imaging unit and the second imaging unit to the image processing unit in the vehicle-mounted camera device according to the present invention are offset by 180 degrees.

FIG. 7 is a diagram in which circuit devices are inserted in the signal lines from the first imaging unit and the second imaging unit to the image processing unit in the vehicle-mounted camera device according to the present invention.

FIG. 8 is a waveform diagram of the signals delayed by inserting the circuit devices in the serial signal lines from the first imaging unit and the second imaging unit to the image processing unit in the vehicle-mounted camera device according to the present invention.

FIG. 9 is a waveform diagram of the signals delayed by inserting the circuit devices in the parallel signal lines from the first imaging unit and the second imaging unit to the image processing unit in the vehicle-mounted camera device according to the present invention.

### DESCRIPTION OF EMBODIMENTS

An embodiment will be described below with reference to the drawings.

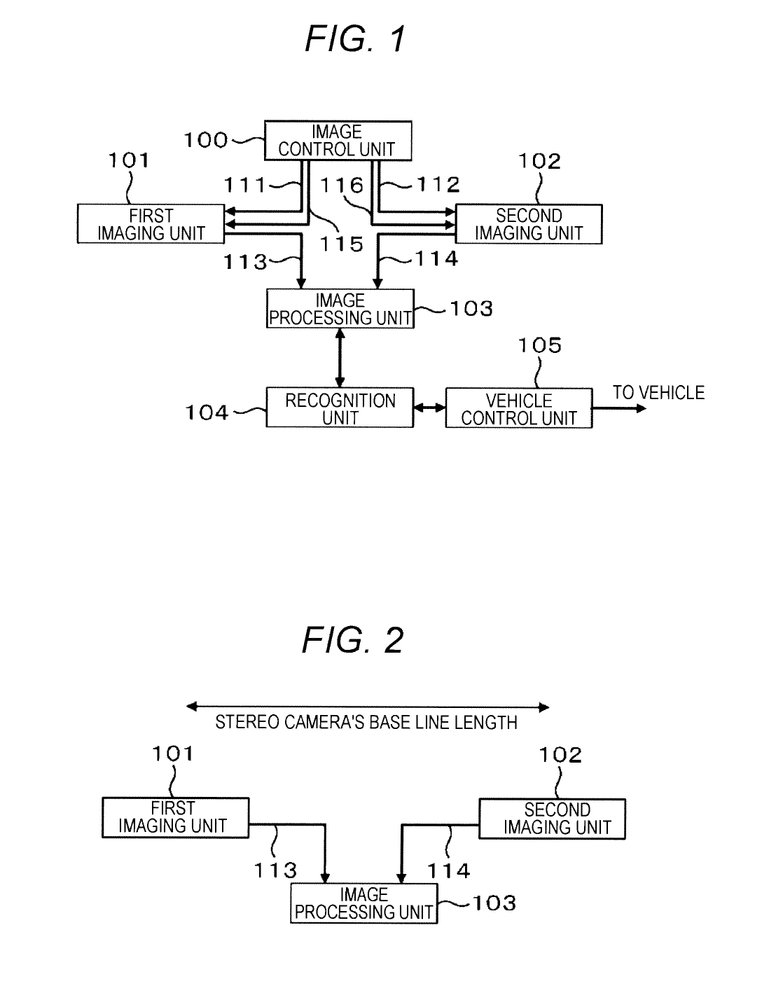

FIG. 1 is a diagram schematically illustrating a vehicle-mounted camera device having two imaging units. The embodiment of the vehicle-mounted camera device as a stereo camera will be described below, but is also applicable to a vehicle-mounted camera device having two monocular cameras.

The stereo camera as a vehicle-mounted camera device has two imaging units (cameras) including a first imaging unit 101 and a second imaging unit 102 at the right and left sides thereof. An image control unit 100 outputs imaging timing signals via a control line 111 (first control line) and a control line 112 (second control line) to control imaging timings of the first imaging unit 101 and the second imaging unit 102. Typically, the imaging timing signals for controlling the imaging timings of the control line 111 and the control line 112 are shutter control signals, or register setting signals for imaging devices or AFE (Analog Front End: A/D converter).

Image data (left image and right image) shot by the first imaging unit 101 and the second imaging unit 102 is transmitted to an image processing unit 103 via a signal line 113 (first signal line) and a signal line 114 (second signal line) together with image data signals, clock signals or image synchronization signals. The transmission timings of the signal line 113 and the signal line 114 are controlled by the transmission timing control signals output from the image control unit 100 via a transmission timing control signal line 115 (first transmission timing control signal line) and a transmission timing control signal line 116 (second transmission timing control signal line). Herein, the transmission timing control signal line 115 and the transmission timing control signal line 116 are clock lines for reference clock, and the like.

The image processing unit 103 calculates a disparity by use of the right and left image data shot by the first imaging unit 101 and the second imaging unit 102. A recognition unit 104 performs a recognition processing to perform an object recognition processing or to calculate a distance based on the result of the image processing. A vehicle control unit 105 makes calculations for vehicle control and issues a vehicle control instruction based on the processing result of the recognition unit 104.

For the stereo camera, the image data shot by the first imaging unit 101 and the second imaging unit 102 has to be shot at the same time for calculating a disparity. Thus, the image control unit 100 controls, based on the signals output via the control line 111 and the control line 112, such that the first imaging unit 101 and the second imaging unit 102 shoot images at the same time.

The image data shot by the first imaging unit 101 and the second imaging unit 102 is transmitted to the image processing unit 103 through the signal line 113 and the signal line 114 together with the image data signals, the clock signals or the image synchronization signals by the transmission timing signals controlled by the transmission timing control signal line 115 and the transmission timing control signal line 116 in the image control unit 100.

The present invention is characterized in that the timings of transmitting the image data signals, the clock signals or the image synchronization signals shot by the first imaging unit 101 and the second imaging unit 102 via the signal line 113 and the signal line 114 are temporally offset.

The image control unit 100 can control the timings of transferring the image data shot by the first imaging unit 101 and the second imaging unit 102 to the image processing unit 103 by use of the transmission timing control signal line 115 and the transmission timing control signal line 116. That is, the image control unit 100 can offset the temporal timings of the signal line 113 and the signal line 114 through which the image data signals, the clock signals or the image synchronization signals shot by the first imaging unit 101 and the second imaging unit 102 are transmitted.

FIG. 1 schematically illustrates the vehicle-mounted camera device, but the recognition unit 104 and the vehicle control unit 105 may be separated from the vehicle-mounted camera device to be mounted on the vehicle. Alternatively, only the vehicle control unit 105 may be mounted on the vehicle.

FIG. 2 is a diagram illustrating transmission of the image data by the vehicle-mounted camera device having two imaging unit or a stereo camera.

The image data shot by the first imaging unit 101 and the second imaging unit 102 is transmitted to the image processing unit 103 via the signal line 113 and the signal line 114 together with the image data signals, the clock signals or the image synchronization signals, but the transmission paths are arranged as long as the base line length (length between the first imaging unit 101 and the second imaging unit 102) illustrated in FIG. 2. The base line length of the stereo camera is designed to have a length of about 20 cm to 100 cm in many cases, and correspondingly the transmission paths of the signal line 113 and the signal line 114 are longer.

Further, as can be seen from the transmission paths of the signal line 113 and the signal line 114 in FIG. 2, the transmission paths form a pseudo dipole antenna, and noises in the signal line 113 and the signal line 114 occur as unnecessary radiation noises via the pseudo dipole antenna.

Therefore, the temporal timings of the signal line 113 and the signal line 114 through which the image data signals, the clock signals or the image synchronization signals shot by the first imaging unit 101 and the second imaging unit 102 are transmitted are offset, and thus the current change amount di/dt per unit time can be restricted for the entire substrate, thereby preventing unnecessary radiation.

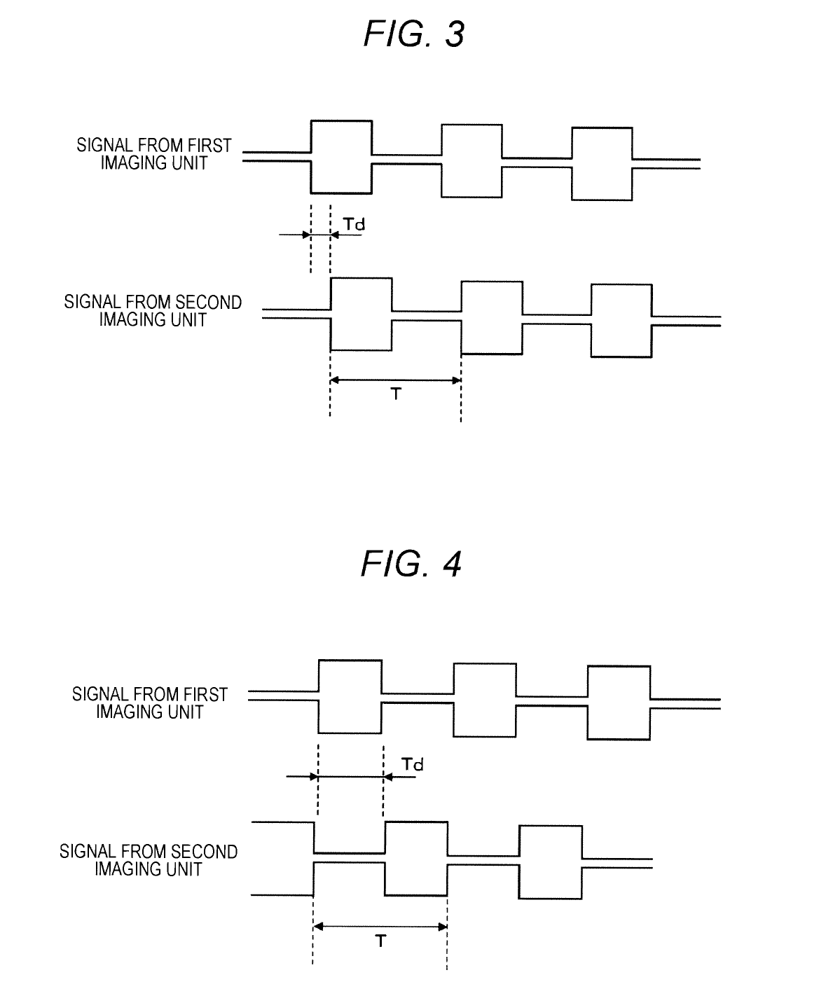

The image control unit 100 illustrated in FIG. 1 can control the timings of transferring the image data shot by the first imaging unit 101 and the second imaging unit 102 to the image processing unit 103 through the transmission timing control signal line 115 and the transmission timing control signal line 116 by the control line 111 and the control line 112, and can offset the timings of the signal line 113 and the signal line 114 through which the image data signals, the clock signals, or the image synchronization signals shot by the first imaging unit 101 and the second imaging unit 102 are transmitted. FIG. 3 illustrates the waveforms in which the timings of the signal line 113 and the signal line 114 are offset by Td.

FIG. 3 is a waveform diagram in which the signals (image data signals, clock signals, or image synchronization signals) transmitted from the first imaging unit 101 and the second imaging unit 102 to the image processing unit 103 via the signal line 113 and the signal line 114 are offset, and illustrates a case in which the signal line 113 and the signal line 114 use two-wire serial differential communication such as LVDS (Low Voltage Differential Signaling). The image data signals, the clock signals or the image synchronization signals are put together into serial signals to be transmitted via the signal line 113 and the signal line 114.

As illustrated in FIG. 3, two signal waveforms (waveforms with one cycle of T) of the signal transmitted from the first imaging unit 101 via the signal line 113 to the image processing unit 103 and the signal transmitted from the second imaging unit 102 via the signal line 114 to the image processing unit 103 are offset by an interval of predetermined time Td, thereby reducing noises due to temporally simultaneous switching. Thus, unnecessary radiation noises can be reduced.

FIG. 4 is a waveform diagram in which the phases of the signal line 113 and the signal line 114 from the first imaging unit 101 and the second imaging unit 102 to the image processing unit 103 are offset by 180 degrees.

As illustrated in FIG. 4, the phases of the signal line 113 and the signal line 114 from the first imaging unit 101 and the second imaging unit 102 to the image processing unit 103 are offset by a predetermined time Td=180 degrees, thereby obtaining an advantage of compensating for a switching current on the driver for driving a signal.

As illustrated in FIG. 3 or FIG. 4, the signal offset time Td is desirable at |Td|<T assuming the signal waveform cycle of T. This is because if the synchronization between the right and left images is remarkably offset for calculating a disparity of the stereo camera, a delay occurs in the subsequent processings.

Typically, in consideration of a setup/hold time of the reception-side IC or a delay time such as waveform rise/fall dullness, the cycle T is desirably set in the range of about |Td|<T-delay time (several nsec to several tens nsec). With the setting, data can be accurately obtained even when the signals are offset.

An internal logic is incorporated such that the image processing unit 103 in FIG. 1 can detect a synchronization offset when the synchronization of the right and left images is remarkably offset due to any EMI noise, so that the image processing unit 103 can notify a non-synchronized image to the recognition unit 104, the vehicle control unit 105 can stop controlling the vehicle, the image processing unit 103 can notify a non-synchronized image to the image control unit 100, and a feedback system capable of finely adjusting the timings of the transmission timing control signals transmitted via the transmission timing control signal line 115 and the transmission timing control signal line 116 can be constructed.

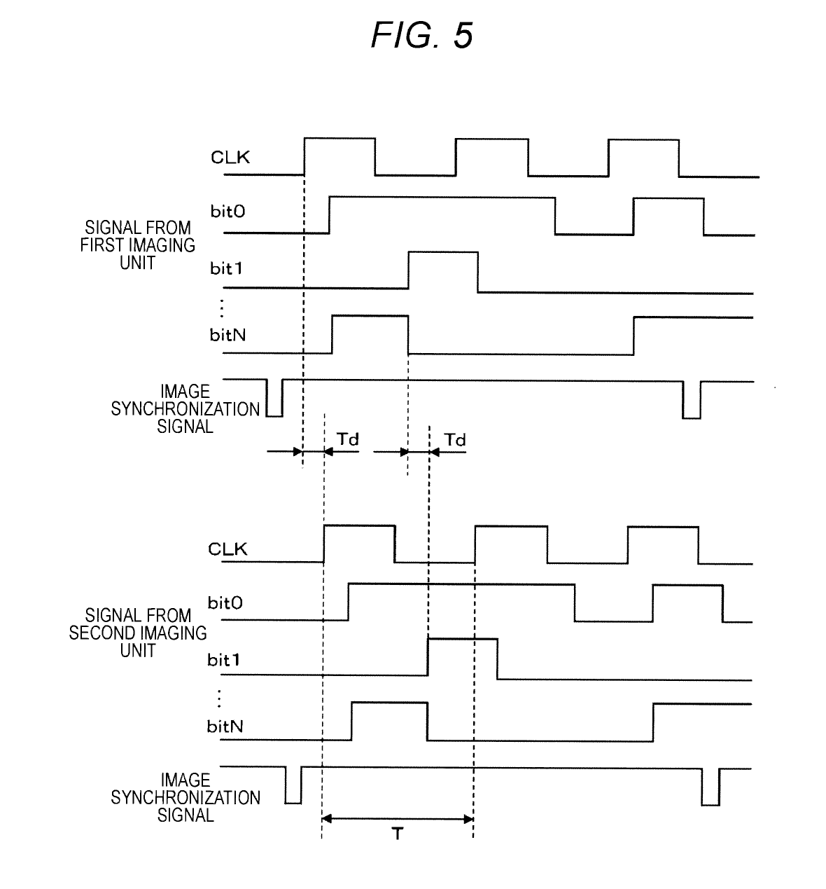

FIG. 5 is a waveform diagram in which the signals transmitted from the first imaging unit 101 and the second imaging unit 102 to the image processing unit 103 via the signal line 113 and the signal line 114 are offset, and illustrates a case in which the signal line 113 and the signal line 114 use parallel communication in which the clock signals (CLK), the image data signals (bit°, bit1, . . . , bitN) or the image synchronization signals are parallel.

Particularly in the parallel communication, a plurality of signal lines through which the image data signals are transmitted are present in many cases (the number of bits also increases when the bus width is large), and the current change di/dt on the simultaneous switching easily increases. Thus, unnecessary radiation noises are easily problematic.

As illustrated in FIG. 5, the parallel communication is realized in a plurality of communication lines through which the clock signals (CLK), the image data signals (each bit), or the image synchronization signals are transmitted, respectively. Typically, the image data signals (bit0 to bitN) and the image synchronization signals are output based on the clock signals (CLK) from the first imaging unit 101 and the second imaging unit 102. The cock signals (CLK), the image data signals (bit0 to bitN) and the image synchronization signals are offset by a predetermined time by the IC or driver circuit to transmit, respectively, and data in the signal lines through which the image data signals are transmitted is latched at the clock rise edge or fall edge on the reception side such as the image processing unit 103. The image synchronization signal is a signal indicating vertical and horizontal separations of the screen, and issues a pulse at a certain timing.

As illustrated in FIG. 5, the signal waveforms of the signal (the clock signal or the image data signal) transmitted from the first imaging unit 101 to the image processing unit 103 via the signal line 113 and the signal (the clock signal, the image data signal or the image synchronization signal) transmitted from the second imaging unit 102 to the image processing unit 103 via the signal line 114 are offset, thereby reducing noises due to the temporally simultaneous switching. Therefore, unnecessary radiation noises can be reduced.

FIG. 5 illustrates a state in which the clock signals, the image data signals and the image synchronization signals are offset by a predetermined time Td between the signal line 113 and the signal line 114.

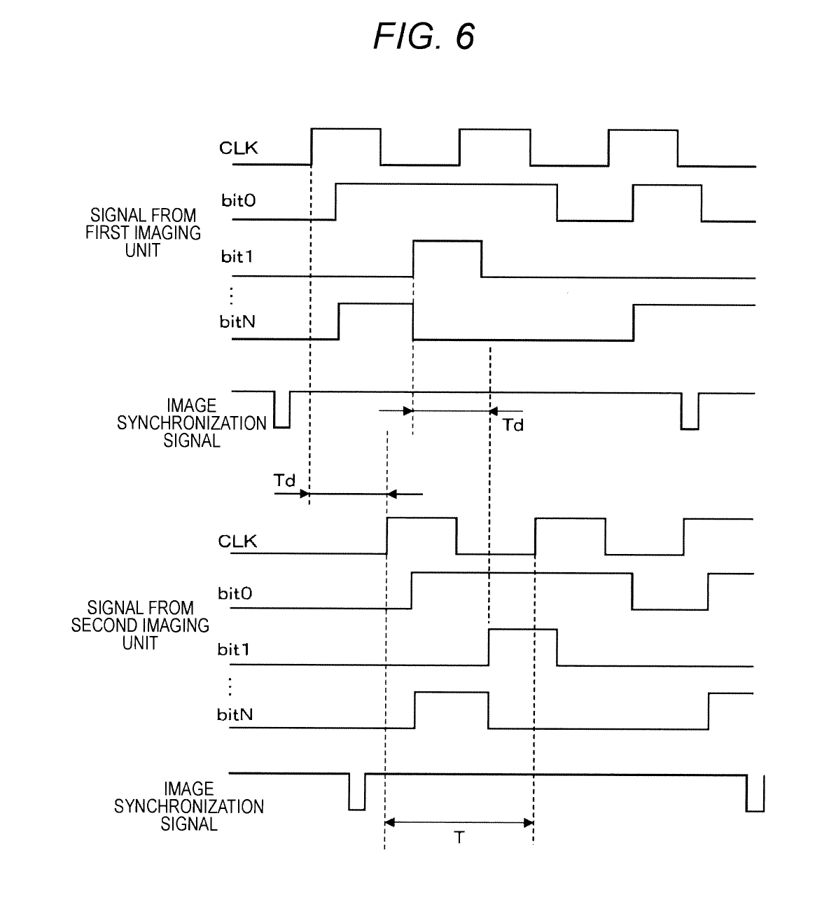

FIG. 6 is a waveform diagram in which the phases of the signal line 113 and the signal line 114 from the first imaging unit 101 and the second imaging unit 102 to the image processing unit 103 are offset by 180 degrees.

As illustrated in FIG. 6, the phases of the signal line 113 and the signal line 114 from the first imaging unit 101 and the second imaging unit 102 to the image processing unit 103 are offset by Td=180 degrees, thereby obtaining an advantage of compensating for a switching current at the driver for driving a signal.

As illustrated in FIG. 5 or FIG. 6, the signal offset time Td is desirably at |Td|<T assuming the signal waveform cycle of T. This is because if the synchronization between the right and left images is remarkably offset for calculating a disparity of the stereo camera, a delay occurs in the subsequent processings.

Similarly as in the serial communication, typically, in consideration of a setup/hold time on the reception-side IC or a delay time such as waveform rise/fall dullness, the cycle T is desirably set in the range of about |Td|<T-delay time (several nsec to several tens nsec). With the setting, data can be accurately obtained even when the signals are offset.

An internal logic is incorporated such that the image processing unit 103 in FIG. 1 can detect a synchronization offset when the synchronization of the right and left images is remarkably offset due to any EMI noise, so that the image processing unit 103 can notify a non-synchronized image to the recognition unit 104, the vehicle control unit 105 can stop controlling the vehicle, the image processing unit 103 can notify a non-synchronized image to the image control unit 100, and a feedback system capable of finely adjusting the transmission timing control signal lines 115 and 116 can be constructed.

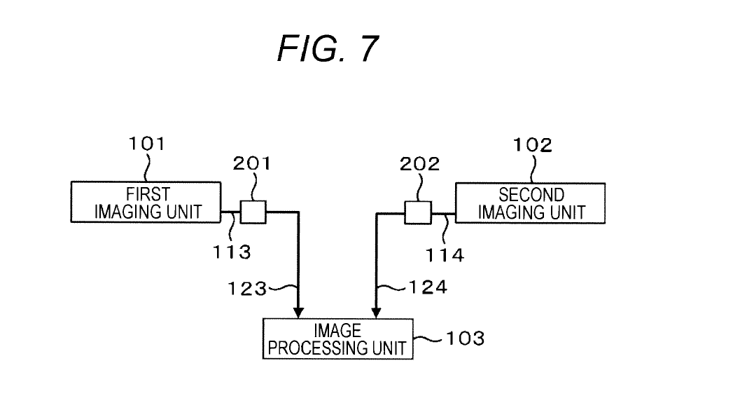

FIG. 7 is a diagram in which a circuit device 201 and a circuit device 202 are inserted in the signal line 113 (the first signal line) and the signal line 114 (the second signal line) from the first imaging unit 101 and the second imaging unit 102 to the image processing unit 103.

Typically, the circuit device 201 and the circuit device 202 are inserted for maintaining the signal quality (restricting signal reflections) in the signal line 113 and the signal line 114 from the first imaging unit 101 and the second imaging unit 102 to the image processing unit 103, respectively, in many cases. Typically, for the circuit device 201 and the circuit device 202, dumping resistors, ferrite beads, coils, capacitors or buffer circuits are inserted in many cases.

Also in the system in which the signal timings of the signal line 113 and the signal line 114 from the first imaging unit 101 and the second imaging unit 102 to the image processing unit 103 cannot be offset, a constant of the circuit device 201 and a constant of the circuit device 202 are intentionally changed so that the properties of the waveforms of a signal line 123 (third signal line) and a signal line 124 (fourth signal line) can be changed after passing the circuit device 201 and the circuit device 202, thereby offsetting the signal timings.

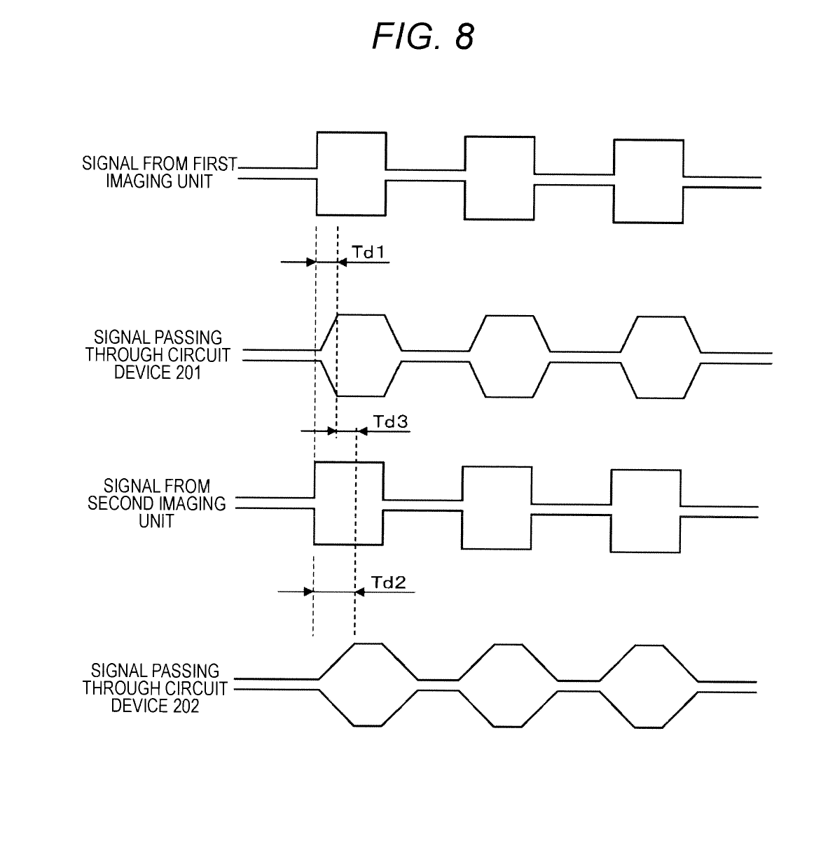

FIG. 8 illustrates a case in which the circuit device 201 and the circuit device 202, which have the mutually different constants, are inserted in the signal line 113 and the signal line 114 from the first imaging unit 101 and the second imaging unit 102 to the image processing unit 103, respectively, and illustrates a case in which the signal line 113 and the signal line 114 use two-wire serial differential communication such as LVDS.

A signal transmitted via the signal line 123 after the signal transmitted from the first imaging unit 101 to the image processing unit 103 passes the circuit device 201 inserted in the signal line 113 is offset by a predetermined time Td1. Similarly, a signal transmitted via the signal line 124 after the signal transmitted from the second imaging unit 102 to the image processing unit 103 passes the circuit device 202 inserted in the signal line 114 is offset by a predetermined time Td2.

Consequently, the signals transmitted via the signal line 123 and the signal line 124 are offset by a predetermined time Td3, thereby reducing noises due to the temporally simultaneous switching. Therefore, unnecessary radiation noises can be reduced.

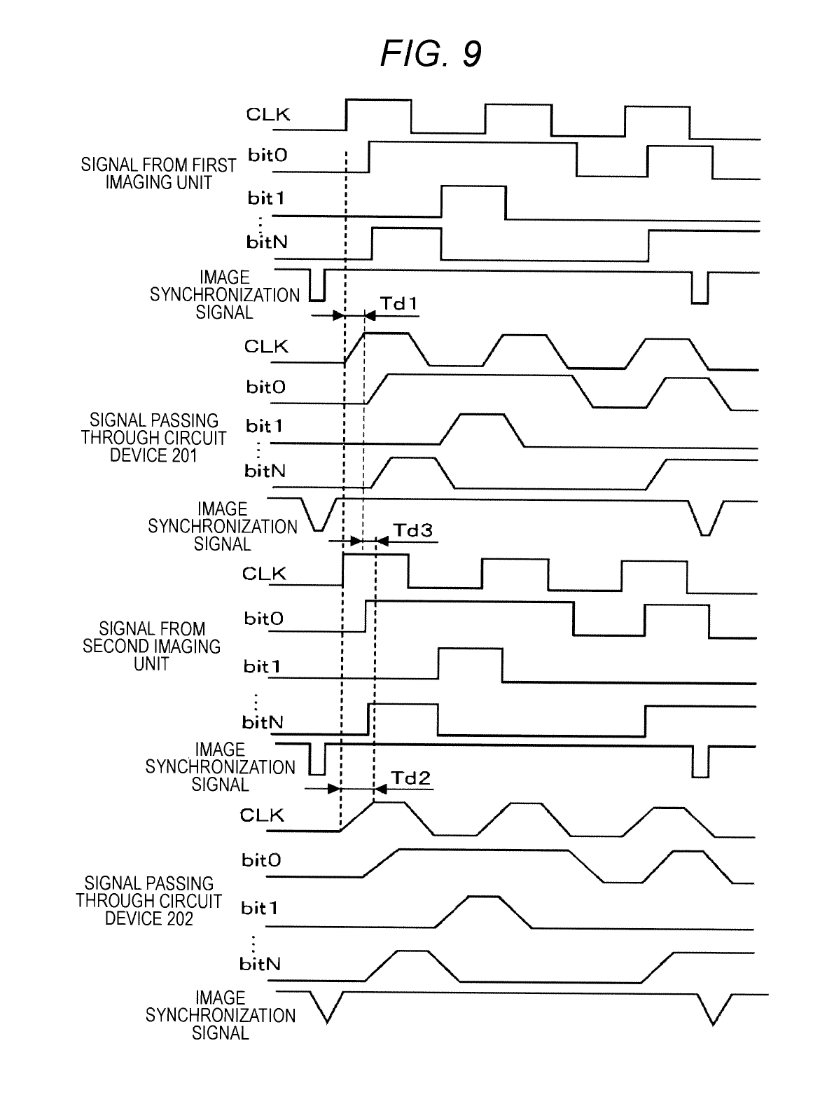

FIG. 9 is a waveform diagram in which the signals transmitted via the signal line 113 and the signal line 114 from the first imaging unit 101 and the second imaging unit 102 to the image processing unit 103 are offset, and illustrates a case in which the signal line 113 and the signal line 114 use parallel communication in which the clock signals CLK, the image data signals or the image synchronization signals are parallel, respectively.

Particularly in the parallel communication, a plurality of signal lines through which the image data signals are transmitted are present in many cases (the number of bits also increases when the bus width is large), and the current change di/dt on the simultaneous switching easily increases. Therefore, unnecessary radiation noises are easily problematic.

A signal (clock signal, image data signal, or image synchronization signal) transmitted via the signal line 123 after the signal transmitted from the first imaging unit 101 to the image processing unit 103 passes the circuit device 201 inserted in the signal line 113 is offset by a predetermined time Td1 from the signal line 113 (clock signal, image data signal or image synchronization signal).

Similarly, a signal (clock signal, image data signal or image synchronization signal) transmitted via the signal line 124 after the signal transmitted from the second imaging unit 102 to the image processing unit 103 passes the circuit device 202 inserted in the signal line 114 is offset by a predetermined time Td2 from the signal (clock signal, image data signal, or image synchronization signal) transmitted via the signal line 114.

Consequently, the signals transmitted via the signal line 123 and the signal line 124 are offset by a predetermined time Td3, thereby reducing noises due to the temporally simultaneous switching. Therefore, unnecessary radiation noises can be reduced.

As described above, according to the present invention, it is possible to reduce unnecessary large radiation noises occurring when the image data signals, the clock signals or the image synchronization signals from the two imaging units are transmitted to the image processing unit 103 at low cost in the vehicle-mounted camera device having the two imaging units.

### REFERENCE SIGNS LIST

100 Image control unit
101 First imaging unit
102 Second imaging unit
103 Image processing unit
104 Recognition unit
105 Vehicle control unit
111, 112 Control line
113, 114 Signal line
201, 202 Circuit device

All of the publications, patents and patent applications cited in the present specifications are incorporated herein by reference.

1. A vehicle-mounted camera device comprising:
a first imaging unit for shooting an image and outputting an image data signal;
a second imaging unit for shooting an image and outputting an image data signal;
an image control unit for outputting imaging timing signals for controlling imaging timings of the first imaging unit and the second imaging unit to the first imaging unit and the second imaging unit, and outputting transmission timing control signals for controlling transmission timings of signals output from the first imaging unit and the second imaging unit to the first imaging unit and the second imaging unit; and
an image processing unit for performing an image processing on the signals output from the first imaging unit and the second imaging unit, wherein
the image control unit temporally offsets a timing of outputting the signal from the first imaging unit to the image processing unit from a timing of outputting the signal from the second imaging unit to the image processing unit based on the transmission timing control signals.

2. The vehicle-mounted camera device according to claim 1, wherein
the signals output from the first imaging unit and the second imaging unit are at least clock signals, image data signals or image synchronization signals.

3. The vehicle-mounted camera device according to claim 1, wherein
the first imaging unit and the second imaging unit shoot images per frame at the same time.

4. The vehicle-mounted camera device according to claim 1, comprising:
a first control line for transmitting the imaging timing signal between the first imaging unit and the image control unit; and
a second control line for transmitting the imaging timing signal between the second imaging unit and the image control unit.

5. The vehicle-mounted camera device according to claim 1, comprising:
a first transmission timing control signal line for transmitting the transmission timing control signal between the first imaging unit and the image control unit; and
a second transmission timing control signal line for transmitting the transmission timing control signal between the second imaging unit and the image control unit.

6. The vehicle-mounted camera device according to claim 1, comprising:
a first signal line for transmitting the signal between the first imaging unit and the image processing unit; and
a second signal line for transmitting the signal between the second imaging unit and the image control unit.

7. The vehicle-mounted camera device according to claim 1, wherein
the image processing unit calculates disparity information based on the image data signals shot by the first imaging unit and the second imaging unit.

8. The vehicle-mounted camera device according to claim 1, comprising: a recognition unit for performing a recognition processing based on the images subjected to the image processing in the image processing unit.

9. The vehicle-mounted camera device according to claim 8, comprising: a vehicle control unit for calculating and outputting a vehicle control signal for controlling the vehicle based on a recognition result subjected to the recognition processing in the recognition unit.

10. A vehicle-mounted camera device comprising:
a first imaging unit for shooting an image and outputting an image data signal;
a second imaging unit for shooting an image and outputting an image data signal;
an image control unit for outputting imaging timing signals for controlling imaging timings of the first imaging unit and the second imaging unit to the first imaging unit and the second imaging unit, and outputting transmission timing control signals for controlling transmission timings of signals output from the first imaging unit and the second imaging unit to the first imaging unit and the second imaging unit;
an image processing unit for performing an image processing on the signals output from the first imaging unit and the second imaging unit;
a first circuit device provided between the first imaging unit and the image processing unit; and
a second circuit device provided between the second imaging unit and the image control unit, wherein a constant of the first circuit device is different from a constant of the second circuit device.

11. The vehicle-mounted camera device according to claim 10, wherein
a timing of outputting the signal from the first circuit device to the image control unit is temporally offset from a timing of outputting the signal from the second circuit device to the image control unit.

12. The vehicle-mounted camera device according to claim 10, wherein
the first circuit device and the second circuit device are any of dumping resistors, ferrite beads, coils, capacitors, or buffer circuits.

13. The vehicle-mounted camera device according to claim 10, wherein
the signals output from the first imaging unit and the second imaging unit are at least clock signals, image data signals or image synchronization signals.

14. The vehicle-mounted camera device according to claim 10, wherein
the first imaging unit and the second imaging unit shoot images per frame at the same time.

15. The vehicle-mounted camera device according to claim 10, comprising:
a first control line for transmitting the imaging timing signal between the first imaging unit and the image control unit; and
a second control line for transmitting the imaging timing signal between the second imaging unit and the image control unit.

16. The vehicle-mounted camera device according to claim 10, comprising:
a first transmission timing control signal line for transmitting the transmission timing control signal between the first imaging unit and the image control unit; and
a second transmission timing control signal line for transmitting the transmission timing control signal between the second imaging unit and the image control unit.

17. The vehicle-mounted camera device according to claim 10, comprising:
a first signal line for transmitting the signal between the first imaging unit and the first circuit device;
a second signal line for transmitting the signal between the second imaging unit and the second circuit device;
a third signal line for transmitting the signal between the first circuit device and the image control unit; and
a fourth signal line for transmitting the signal between the second circuit device and the image control unit.

18. The vehicle-mounted camera device according to claim 10, wherein
the image processing unit calculates disparity information based on the image data signals shot by the first imaging unit and the second imaging unit.

19. The vehicle-mounted camera device according to claim 10, comprising: a recognition unit for performing a recognition processing based on the images subjected to the image processing in the image processing unit.

20. The vehicle-mounted camera device according to claim 19, comprising: a vehicle control unit for calculating and outputting a vehicle control signal for controlling the vehicle based on a recognition result subjected to the recognition processing in the recognition unit.
